(19) United States
(12) Patent Application Publication
(10) Pub. No.: US 2008/0263854 A1
(43) Pub. Date: Oct. 30, 2008

(54) METHOD OF MAKING A MOTOR -VEHICLE ANTENNA ASSEMBLY

(75) Inventors: Ingmar PETERSEN, Esslingen (DE); Bernd SCHWARZ, Waldorfhaslach (DE); Markus PFLETSCHINGER, Eningen (DE)

Correspondence Address: K.F. ROSS P.C., 5683 RIVERDALE AVENUE, SUITE 203 BOX 900, BRONX, NY, 10471-0900, US

(73) Assignee: Hirschmann Car Communication GmbH

(21) Appl. No.: 12/061,877

(22) Filed: Apr. 3, 2008

(30) Foreign Application Priority Data
Apr. 4, 2007 (DE) 102007016235.0

(51) Int. Cl. H01P 11/00

(52) U.S. Cl. 29/600; 29/601; 29/825

(57) ABSTRACT

A motor-vehicle antenna assembly is made by first printing on a face of a substantailly flat deformable plastic film a layer of an electrically conductive paste. Then the film is permanently plastically deformed into a three-dimensional shape corresponding to a shape of an installation location of a motor vehicle. The plastically deformed film with the printed layer is then fitted to the installation location.

The invention relates to a method of making an antenna assembly for vehicles according to the features of claim 1.

The antenna assembly primarily comprises at least one flat substrate made of plastic, for example a plastic film, on which electrically conductive structures are provided that act as radiators and that may be used to receive and/or transmit high-frequency signals (antenna structure).

It is known from DE 10 2005 034 082.2 to print a plastic film with an electrically conductive paste, for example in a screen printing process, to make the desired antenna structures by means of the printed paste. This plastic film together with the imprinted antenna structures is then mounted, for example glued flat, on a vehicle component. The size and shape of the region of the vehicle part on which the plastic film is to be mounted must correspond to the size and shape of the plastic film. Thus, in this known design it is not possible to apply the flat plastic film to a vehicle component having a complex shape.

Furthermore, a method of making an antenna assembly and an antenna assembly produced thereby is known from DE 10 2005 034 085.7, in which a plastic film is provided with antenna structures in a manner analogous to that described above. The plastic film prepared in this way is then inserted into a mold, preferably an injection mold, and the mold is filled with additional plastic material, after which the finished vehicle component, which contains the antenna assembly, may be removed from the mold. Here as well, it is disadvantageous that the region of the mold in which the plastic film is inserted must have a substantially flat shape, or at the minimum a slight curvature, so that when the mold is filled with plastic material the plastic film joins this filled material (injected plastic, for example) over a large surface area. In this case as well, it is not possible to produce vehicle components with complex designs having, for example, indentations, bridges, curvatures with narrow radii, and the like.

The object of the invention, therefore, is to provide a method that allows production of vehicle components having complex structures or complex geometric shapes, and that may be provided with an antenna assembly, or that are made with an antenna assembly built in.

This object is achieved by use of the following method:

According to the invention, an initially flat plastic film is composed of a deformable material, and after printing undergoes shaping in such a way that the prepared plastic film together with the antenna structures is permanently and plastically deformed, so that after this deformation a three-dimensional shape results that corresponds to the installation location of the vehicle component.

The basis once again is a plastic film on which electrically conductive structures are situated. Here as well, the electrically conductive structures may be an electrically conductive paste that is printed on the plastic film. The plastic film, and preferably also the electrically conductive structures that have been applied, have the material property of being permanently deformable. In this case the plastic film is composed of a thermoplastically deformable material, for example, and is subjected to the effects of heat so that the prepared plastic film together with the antenna structures are permanently plastically deformed in such a way that, following this deformation, a shape results that corresponds to the installation location of the vehicle component. The method may be a deep-drawing process, for example, in which the plastic film under is shaped by heat on a positive mold that corresponds to a negative of the vehicle component (or vice versa), so that after the shaping the positive molded article has acquired a geometric shape that corresponds to the installation location on the vehicle component. This antenna assembly, after edges have been trimmed off and contact points or plug-in connectors have been attached, for example, may then be permanently (by gluing, for example) or detachably joined to the vehicle component.

A further important aspect of the invention as described below is that the structure of the electrically conductive structures mounted on the planar plastic film is not the same as that after the shaping, so that the antenna structures are not formed into their final geometric configuration until after the plastic film has been shaped. This means that, for example, before the shaping the electrically conductive structures are not able to act as an antenna and are able to act as an antenna only after the electrically conductive structures together with the substrate film have been shaped. However, this depends greatly on the degree of deformation, so that it is also naturally possible for the structures mounted on the plastic film before the deformation to be able to act as antennas (although this is not a requirement), and for their optimal effect as an antenna structure to be achieved only after the plastic film has been shaped into its final complex geometric shape. Of course, in the selection of materials for the electrically conductive structures it is important that this material likewise be shapeable during deformation, and that no tears occur that could impair the function of the subsequent antenna structure.

In summary, the invention is based on the concept that, from a two-dimensional (i.e. planar) structure as substrate upon which electrically conductive structures are mounted, a shaping process is used to produce a three-dimensional structure that after the shaping into its final form corresponds to the shape of the vehicle component, and is applied to the vehicle component, and in every case, following the shaping process the electrically conductive structures together with the structures that are shaped form the antenna structure.

1-6. (canceled)

7. A method of making a motor-vehicle antenna assembly, the method comprising the steps of sequentially:
printing on a face of a substantailly flat deformable plastic film a layer of an electrically conductive paste;
permanently plastically deforming the film into a three-dimensional shape corresponding to a shape of an installation location of a motor vehicle; and
fitting the plastically deformed film with the printed layer to the location.

8. The method defined in claim 7 wherein the layer is deformed with the film.

9. The method defined in claim 7 wherein the film is a thermoplastic resin and is deformed by being heated, deformed, and then cooled.

10. The method defined in claim 7 wherein the layer is applied by screen printing.

11. The method defined in claim 7 wherein the film is deformed by being heated and deep drawn in a mold having a surface shaped like the location.

12. The method defined in claim 7, further comprising the steps of:
trimming edges off the deformed film and providing it with contacts and connectors before fittign it to the location.
